(19) United States
(12) Patent Application Publication
(10) Pub. No.: US 2025/0153325 A1
(43) Pub. Date: May 15, 2025

(54) APPARATUS FOR VALVE SPRING COMPRESSION IN AN INTERNAL COMBUSTION ENGINE AND METHODS OF USE

(71) Applicant: Mustafa Aladarbi, Collierville, TN (US)

(72) Inventor: Mustafa Aladarbi, Collierville, TN (US)

(21) Appl. No.: 18/948,265

(22) Filed: Nov. 14, 2024

Related U.S. Application Data
(60) Provisional application No. 63/548,433, filed on Nov. 14, 2023.

(51) Int. Cl. B25B 27/26

(52) U.S. Cl. CPC B25B 27/26

(57) ABSTRACT

An apparatus for valve spring compression in an internal combustion (IC) engine is disclosed. The apparatus includes an elongated rod having fixing seats connecting the IC engine. The elongated rod includes a fixed first lever, and a second lever slidably connected to the elongated rod. The second lever includes compression columns. The second lever pushes down such that the compression columns compress a valve spring for removal or replacement of a valve seal or the valve spring. The apparatus includes a keeper tool connected to the compression columns for installing valve keepers and/or the valve seat. The apparatus includes a camshaft removal tool configured to mount over a cylinder head in order to remove a camshaft to access the valve spring. The apparatus helps to remove or replace valve springs and/or valve seals from the engine without requiring the removal of the engine from a support frame.

### CROSS-REFERENCE TO RELATED APPLICATIONS

The present application claims benefit of U.S. Provisional Application No. 63/548,433, filed Nov. 14, 2023, which is incorporated herein in its entirety and referenced thereto.

### BACKGROUND OF THE INVENTION

### Field of the Invention

The present invention relates to automobile engines and engine parts. More specifically, the present invention relates to an apparatus for valve spring compression in an internal combustion engine for removal and replacement of a valve seal or broken valve spring.

### Description of the Prior Art

It is known that components in an internal combustion (IC) engine for an automobile wear out over time. The worn out or broken components need to be replaced for proper functioning of the IC engine. An example of the component includes a valve seal that positions within a cylinder head of the IC engine. A typical valve assembly allows or restricts the flow of fluid or gas to and from combustion chambers or cylinders during the operation of the IC engine. The valve assembly includes a stem having a valve head that forms a valve seal against a valve seat in order to prevent or allow the flow of gases through a cylindrical port. The valve assembly includes a valve spring. The valve spring maintains the valve head in a tightly sealed position unless a rotating cam pushes it. The valve spring connected to the stem for easy removal from one end of the shaft. In order to replace the valve seal, the valve spring needs to be compressed from its point of attachment to the stem.

Several tools for removal and replacement of the valve spring and the valve seal have been disclosed in the past. Once such a tool is disclosed in a U.S. Pat. No. 6,871,390, entitled “Spring detachment device for automobile” (“the '390 patent”). The '390 patent discloses a spring detachment device that includes two fixing seats, a transverse rod, and an operation mechanism. Thus, the spring detachment device can be operated by a single person only, thereby saving the manual work and the working time. In addition, the distance between the operation mechanism and the air door can be adjusted easily and conveniently, thereby facilitating the user replacing the spring.

Another tool is disclosed in a U.S. Pat. No. 7,765,664, entitled “Cylinder valve spring compressor” (“the '664 patent”). The '664 patent discloses a valve spring compressor apparatus and method for compressing cylinder valve springs for the removal and installation of their locks or keepers and for replacement of valve stem seals or broken springs on an internal combustion engine, while the cylinder head is mounted on the engine or supported on a work bench. A compressor tool adjustably mounted on a support assembly temporarily secured over the cylinder head has a pivoting hand lever and spring biased push rod which, when manually depressed, moves a compressing member at the bottom of the push rod downward to engage and depress the valve spring and its retainer to gain access and removal of the lock or keeper though openings in the compressor tool.

Another tool is disclosed in a U.S. Pat. No. 9,364,929, entitled “Specified engine valve removal tool” (“the '929 patent”). The '929 patent discloses an engine valve spring compression tool to assist in removing and replacing valve stem seals without removing a cylinder head from the engine. The tool having exhaust and intake valve connecting stems that provide fulcrum points, a compression bushing assembly to compress the valve spring, and a hook assembly to lock the tool in compression to allow the ancillary work to be completed.

Yet another tool is disclosed in a U.S. Pat. No. 9,862,082, entitled “Removal and installation device for valve keepers” (“the '082 patent”). The '082 patent discloses a tool for installing or removing valve keepers. One end of the tool is configured to easily remove valve keepers, while the other end of the tool is configured to easily install valve keepers. This valve tool can be further connected to an engine-mounted lever assembly for increasing leverage on the tool during use.

Although the above discussed disclosures are useful, they still have problems and present incomplete solutions. For instance, most of the existing tools remain at the same position after compressing the valve spring and obstruct the user while removing and replacing the valve seal. This results in inconvenience to the user and prolongs the duration for removing or replacing the valve seal or valve spring in the IC engine. Further, some of the tools require the IC engine to be removed from the automobile for removing or replacing the valve seal.

Therefore, there is a need in the art to provide an improved apparatus for valve spring compression in an internal combustion (IC) engine for removal and replacement of a valve seal or broken valve spring without having to remove the IC engine from the automobile.

### SUMMARY OF THE INVENTION

It is an object of the present invention to provide an apparatus or tool that avoids the drawbacks of known valve removal tools.

It is another object of the present invention to provide an apparatus for valve spring compression in an internal combustion engine for removal and replacement of a valve seal or broken valve spring without having to remove an internal combustion (IC) engine from an automobile.

It is another object of the present invention to provide an apparatus for removing and replacing a valve seal or broken valve spring, the apparatus having a lever that can slide along an elongated rod or transverse rod.

It is another object of the present invention to provide an apparatus having a lever that can be put back to prevent it from obstructing while removal or replacement of the valve spring and/or valve seal in the IC engine.

In order to overcome one or more objects, the present invention presents an apparatus for compressing a valve spring in an internal combustion (IC) engine for removal or replacement of a valve seal or valve spring. The apparatus includes an elongated rod having fixing seats connecting the IC engine. The elongated rod includes a fixed first lever, and a second lever slidably connected to the elongated rod. The second lever includes compression columns. The second lever pushes down to such that the compression columns compress a valve spring for removal or replacement of a valve seal or the valve spring. The apparatus includes a keeper tool connected to the compression columns for installing valve keepers and/or the valve seat. The apparatus includes a camshaft removal tool configured to mount over a cylinder head in order to remove a camshaft to access the valve spring. The apparatus helps to remove or replace valve springs and/or valve seals from the engine without requiring the removal of the engine from a support frame.

Further, the compression columns include a compression bushing at distal end interfacing with the valve spring. The compression columns and the second lever are pivotable to a position away from said valve spring to prevent obstruction at the time of removal or replacement of the valve seal and/or the valve spring.

In addition, the apparatus includes a keeper tool connected to the compression columns for installing valve keepers and/or the valve seat. Further, the apparatus includes a camshaft removal tool configured to mount over a cylinder head in order to remove a camshaft to access the valve spring. The camshaft removal tool includes a body having extension legs, extension members and extension arms that are operatively connected to cam caps and rocker arms positioned along the camshaft. The camshaft removal tool is pressed to release springs of the camshaft to enable access to the valve spring.

In one advantageous feature of the present invention, the apparatus helps to remove or replace valve springs and valve seals from the IC engine without requiring the removal of the IC engine from a support frame. The user has to simply remove an engine cover and operate the apparatus to remove and replace the valve seal in the IC engine.

In one advantageous feature of the present invention, the elongated rod allows the second lever to be fixed anywhere along its length. The apparatus aligns with the valve spring and helps in removal or replacement of several valve springs and valve seals positioned in a row.

In another advantageous feature of the present invention, the apparatus allows the second lever to be put back, preventing it from obstructing while the user is removing and/or replacing the valve spring and/or the valve seal.

Another advantageous feature of the present invention is that the apparatus has a provision to connect the keeper tool to position the valve keepers over the valve spring in order to compress and connect the valve keepers to the valve spring.

These and other objects of the present invention will be apparent from review of the following specification and the accompanying drawings.

### BRIEF DESCRIPTION OF THE DRAWINGS

FIG. 1 illustrates an environment in which an apparatus for compressing a valve spring in an internal combustion (IC) engine is implemented, in accordance with one exemplary embodiment of the present invention.

FIG. 2 illustrates a perspective view of the apparatus, in accordance with one embodiment of the present invention.

FIG. 3 illustrates an enlarged view of a lever of the apparatus, in accordance with one embodiment of the present invention.

FIG. 4 illustrates the apparatus connected to the IC engine, in accordance with one embodiment of the present invention.

FIG. 5 illustrates the lever being pushed down to compress a valve spring, in accordance with one embodiment of the present invention.

FIG. 6 illustrates the feature of the lever being put back, in accordance with one embodiment of the present invention.

FIG. 7 illustrates the lever placed at the back, in accordance with one embodiment of the present invention.

FIG. 8 illustrates the apparatus connecting a keeper tool, in accordance with one embodiment of the present invention.

FIG. 9 illustrates a perspective view of a camshaft removal tool, in accordance with one embodiment of the present invention.

FIG. 10 illustrates the camshaft removal tool placed over a cylinder head, in accordance with one embodiment of the present invention.

FIG. 11 illustrates the feature of tightening the camshaft removal tool prior to removal of a camshaft from the cylinder head for accessing the valve spring, in accordance with one embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed apparatus. However, it will be apparent to those skilled in the art that the presently disclosed invention may be practiced without these specific details. In some instances, well-known structures and devices are shown in functional or conceptual diagram form in order to avoid obscuring the concepts of the presently disclosed apparatus.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of an apparatus, it is to be further understood that numerous changes may arise in the details of the embodiments of the apparatus. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

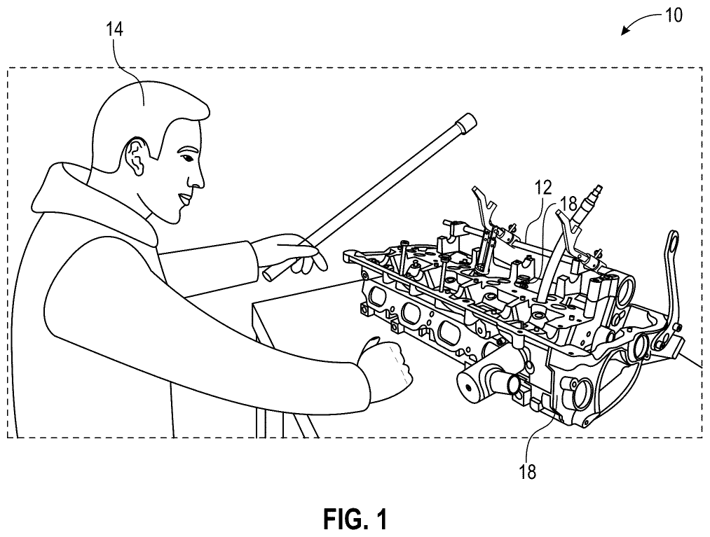

Various features and embodiments of an apparatus for valve spring compression in an internal combustion engine for removal and replacement of a valve seal or broken valve spring are explained in conjunction with the description of FIGS. 1-11.

FIG. 1 shows an environment 10 in which an apparatus 12 for valve spring compression in an internal combustion engine for removal and replacement of a valve seal or broken valve spring implements, in accordance with one exemplary embodiment of the present invention. Apparatus 12 can also be referred to as a valve seal removal tool, oil seal valve remover, etc. Apparatus 12 is operated by a user 14 to remove a valve assembly 16 in an internal combustion (IC) engine 18. In accordance with the present invention, apparatus 12 helps to remove and replace a valve seal (not shown) and/or valve spring without having to remove IC engine 18 from an automobile (not shown) such as a car, for example.

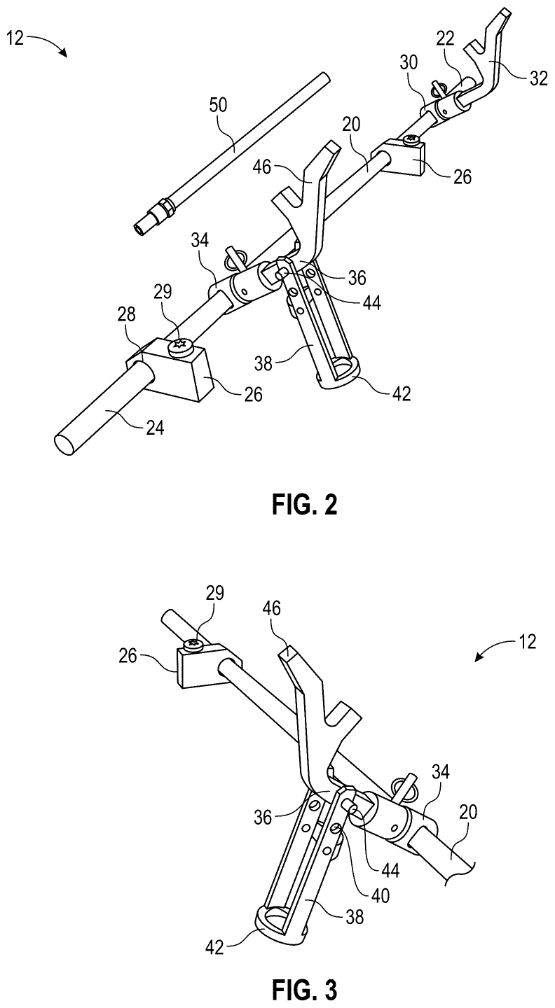

FIG. 2 shows a perspective view of apparatus 12, in accordance with one embodiment of the present invention. Apparatus 12 includes an elongated rod or axle or transverse rod or transverse bar 20. Elongated rod 20 has a tubular structure and is made of a metal or any other suitable material. Elongated rod 20 has a first end 22 and a second end 24. As can be seen, elongated rod 20 includes a base or shoe or fixing seat or fixing part 26. Fixing seat 26 indicates a bracket that helps to connect apparatus 12 to a connecting member 52 at IC engine 18. In one example, fixing seat 26 includes a hole 28 for drawing elongated rod 20 through it. Fixing seat 26 connects to connecting member 52 with the help of a fastener 29. At first end 22, elongated rod 20 includes a first lever connecting member 30. First lever connecting member 30 positions at the distal end of elongated rod 20. In one example, first lever connecting member 30 helps to connect first lever 32 to elongated rod 20. Here, first lever 32 acts as an external lever for operating elongated rod 20.

Further, elongated rod 20 includes a second lever connecting member 34. Second lever connecting member 34 helps to connect a second lever 46 to elongated rod 20. FIG. 3 shows an enlarged view of apparatus 12 showing second lever 46 connected to elongated rod 20. In the present embodiment, second lever connecting member 34 slides along the length of elongated rod 20 to align second lever 46 with valve assembly 16 for removal and replacement of a valve seal or broken valve spring. In one example, apparatus 12 includes an extending member 36. Extending member 36 extends perpendicularly from second lever connecting member 34. Further, apparatus 12 includes a second lever 46. Second lever 46 extends from extending member 36 at an outward angle facing upwards. In one example, extending member 36 and second lever 46 come as a single component whereby the component is straight for about half its length forming extending member 36 and raises up at an angle for the remainder length forming second lever 46.

Further, apparatus 12 includes compression columns or piston fork 38. In one example, compression columns 38 include holes 40. Compression columns 38 connect to extending member 36 on both sides with the help of pivot connector 44 drawing through holes 40, as can be seen from FIG. 3. Pivot connector 44 helps to connect compression columns 38 pivotably with respect to extending member 36. Compression columns 38 include a compression bushing 42 at their distal end. Compression bushing 42 comes in a circular or any other suitable configuration. In one example, apparatus 12 has an operating member 50. Operating member 50 indicates a piping hose or metal tube or tubular spanner in applying torque to turn an object e.g., first lever 32 or second lever 46.

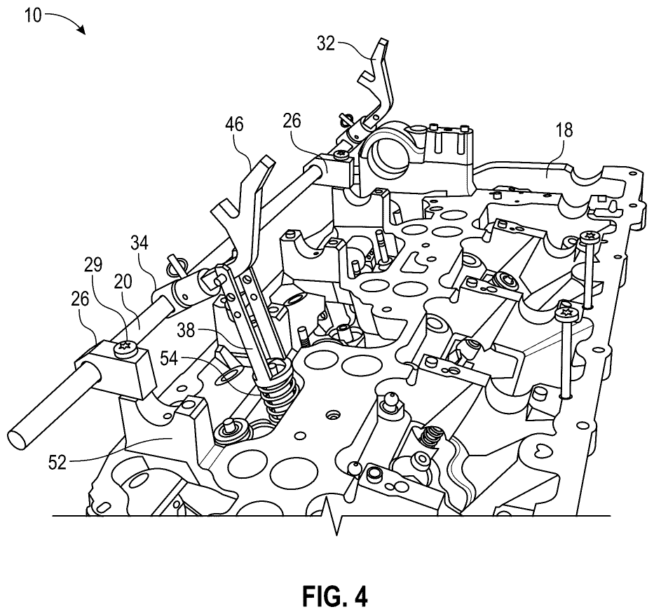

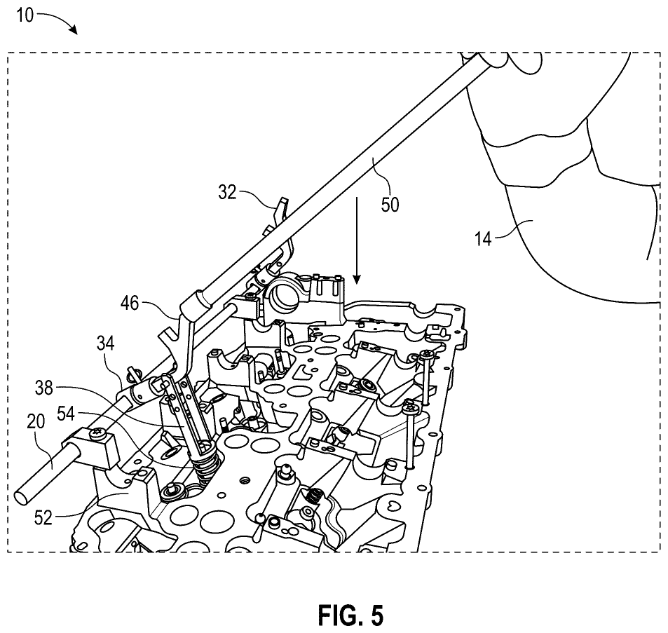

FIG. 4 shows the feature of apparatus 12 connected to IC engine 18, in accordance with one embodiment of the present invention. As can be seen, each fixing seat 26 connects to connecting member 52 at first end 22 and second end 24. After connecting, compression columns 38 align with valve assembly 16. Specifically, compression columns 38 are made to position over a valve spring 54 of valve assembly 16. Subsequently, operating member 50 is connected to second lever 46, as shown in FIG. 5. Here, user 14 pushes down operating member 50 in order to push down second lever 46 such that compression columns 38 compress valve spring 54. Compressing valve spring 54 provides access to valve keepers or locks (not shown) of a valve seat or spring retainer (not shown) at a valve stem 55. Here, user 14 uses a tool or valve seal remover tool or valve seal plier (not shown) to remove valve keepers and the valve seat. In one example, compression columns 38 align with the top of valve assembly 16 and apply pressure to expose the valve keepers at top of valve assembly 16. Subsequently, the valve keepers are removed with the help of a magnet (not shown). Subsequently, user 14 removes valve spring 54 from valve assembly 16.

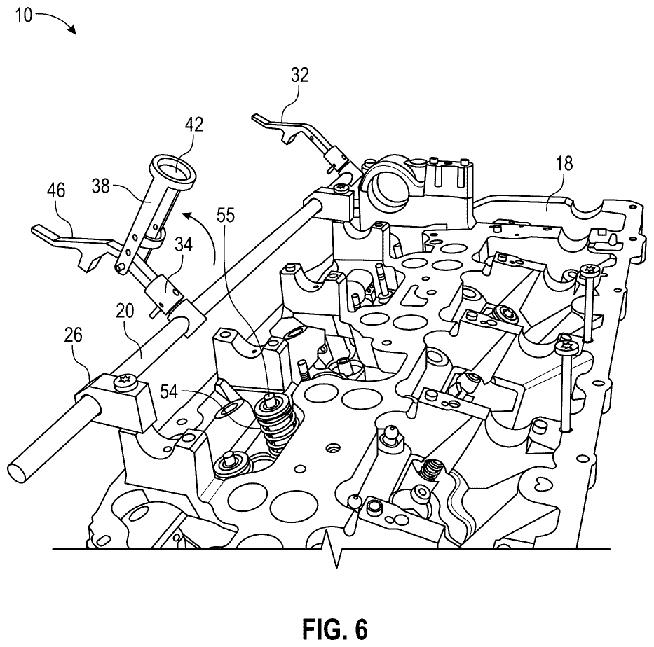

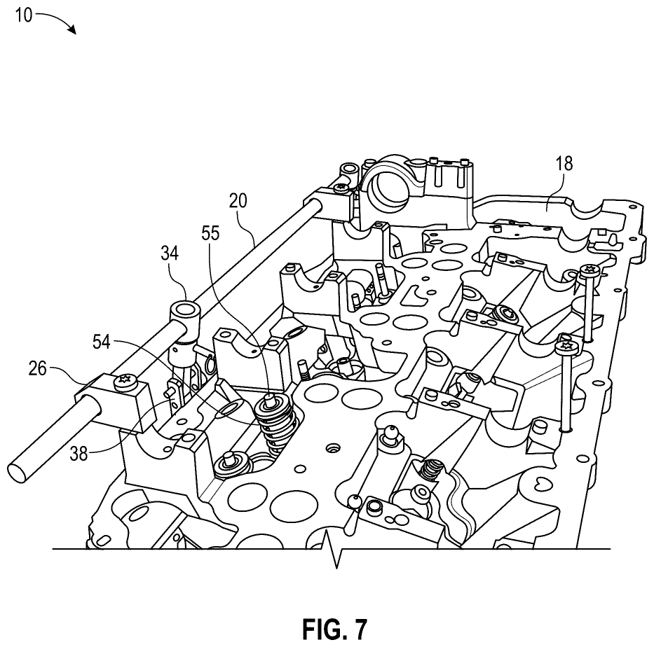

Concurrently or consecutively, user 14 uninstalls compression columns 38 from valve spring 54. This is done to put second lever 46 backwards to prevent second lever 46 from obstructing while user 14 tries to remove or replace a valve seal (not shown). FIG. 6 shows the feature of lifting compression columns 38 in order to place compression columns 38 and second lever 46 at the back. FIG. 7 shows the feature of compression columns 38 and second lever 46 put back completely providing a clear area for removal and replacement of a valve seal.

In order to remove and replace the valve seal, user 14 removes valve spring 54 from valve assembly 16. At this point, air is pumped into a cylinder head of the valve seal via an air pumping hose (not shown). A person skilled in the art understands that air is continuously pumped throughout to keep valve spring 54 in an upward position. Removing valve spring 54 allows access to the valve seal positioned underneath. User 14 uses the tool to remove the valve seal. Subsequently, user 14 inserts a new valve seal with the help of the tool. User 14 places valve spring 54 above the new valve seal.

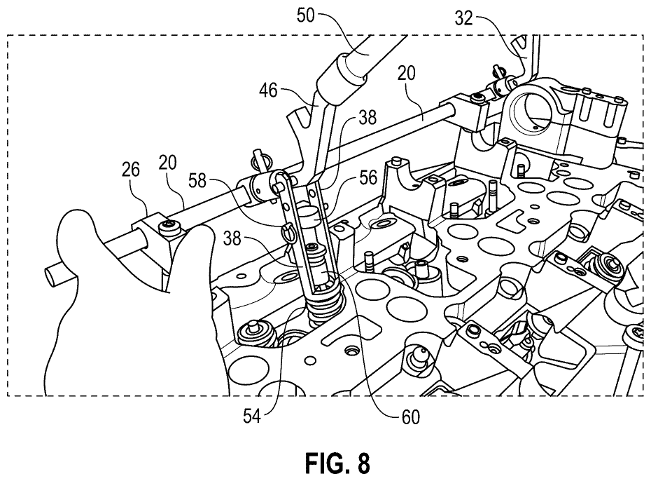

Apparatus 12 further presents a keeper tool 56 connected to compression columns 38 at holes 40 with the help of a retaining member 58. Keeper tool 56 has a keeper body 60 configured to receive the valve keepers and/or the valve seat. Here, user 14 aligns compression columns 38 with valve spring 54. After aligning, user 14 installs keeper tool 56 to compression columns 38, as shown in FIG. 8. After connecting, user 14 positions keeper body 60 over valve spring 54 with valve keepers and/or the valve seat in keeper body 60. Subsequently, user 14 connects operating member 50 to second lever 46 and presses operating member 50 down to connect the valve keepers and the valve seat over valve spring 54 to complete the installation of the new valve seal in valve assembly 16.

The above embodiment describes removal and replacement of the valve seal positioned underneath valve spring 54. The above process is repeated to remove and replace valve spring 54 by compressing compression columns 38 via second lever 46 without departing from the scope of the present invention.

In one implementation, apparatus 12 includes a camshaft removal tool 100. Camshaft removal tool 100 is used for removing camshaft 119 for accessing valve spring 54. In order to access camshaft 119, at first, user 117 removes a valve cover (not shown) of a cylinder head 118.

FIG. 9 shows camshaft removal tool 100, in accordance with one embodiment of the present invention. Camshaft removal tool 100 is made of a suitable material such as a metal. Camshaft removal tool 100 includes a body 102. Body 102 comes in a rectangular or any other configuration depending on the need. Body 102 encompasses a first groove 104 and a second groove 106. In one example, second groove 106 has a larger diameter than first groove 104, or vice versa. Body 102 presents extension legs 108. Extension legs 108 extend from distal ends of body 102. Further, body 102 encompasses extension members 110. Extension members 110 extend upwards in perpendicular to body 102. In one example, extension members 110 extend from the center of body 102. Each of extension members 110 presents a hole 112. Further, camshaft removal tool 100 encompasses extension arms 114. Extension arms 114 extend perpendicularly to body 102 and include arm holes 116.

The presently disclosed camshaft removal tool 100 is positioned over a cylinder head 118 for removing camshaft 119. FIG. 10 shows the feature of camshaft removal tool 100 positioned over cylinder head 118, in accordance with one embodiment of the present invention. Here, camshaft removal tool 100 positions over a shaft securing member (not shown). Subsequently, user 117 inserts a first connector 125 via first groove 104 (FIG. 11). As can be seen from FIG. 10, camshaft removal tool 100 sits over cam caps 120 and adjacent rocker arms 121 positioned along camshaft 119. In one example, an adjuster tool 124 may be used to align camshaft removal tool 100 over cylinder head 118. Further, an alignment rod 126 may be used to connect to holes 112 of extension members 110 via connecting screws 128, as shown in FIG. 11. Further, arm screws 122 may be inserted into arm holes 116. A tool 130 is used to tighten arm screws 122. After connecting, camshaft removal tool 100 may be pressed to remove/release springs (not shown) in order to remove camshaft 119 from cylinder head 118. After removing camshaft 119, user 117 is able to view/access valve assembly 16 for removal and replacement of a valve seal or broken valve spring, as explained above.

The presently disclosed apparatus provides several advantages over the prior art. The apparatus helps to remove or replace valve springs and/or valve seals from an engine without requiring the removal of the engine from a support frame. The elongated rod allows the lever to be fixed anywhere along its length. The apparatus aligns with the valve spring and helps in removal or replacement of several valve springs and valve seals positioned in a row. Further, the apparatus allows the lever to be put at the back preventing it from obstructing while the user is removing the valve spring and replacing the valve seal with a new valve seal. The apparatus is used to align the keeper tool to position the valve keepers over the valve spring to compress and connect the valve keepers to the valve spring.

A person skilled in the art appreciates that the railroad safety system can come in a variety of shapes and sizes depending on the need and comfort of the user. Further, many changes in the design and placement of components may take place without deviating from the scope of the presently disclosed apparatus.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

1. (canceled)

2. An apparatus for compressing a valve spring in an internal combustion (IC) engine for removal or replacement of a valve seal or said valve spring, said apparatus comprising:
an elongated rod having a first end and a second end;
a first lever connected at said first end of said elongated rod;
a second lever slidably connected to said elongated rod;
compression columns pivotably connected to said second lever; and
fixing seats positioned at said elongated rod for securing said apparatus to an internal combustion (IC) engine,
wherein said second lever is pushed down such that said compression columns compress a valve spring for removal or replacement of a valve seal or said valve spring.

3. The apparatus of claim 2, wherein said compression columns comprise a compression bushing at distal end interfacing with said valve spring.

4. The apparatus of claim 2, wherein said second lever comprises an extending member connected to said elongated rod via a second lever connecting member.

5. The apparatus of claim 4, wherein said second lever extends at an angle from said extending member.

6. The apparatus of claim 4, wherein said compression columns connect to said extending member.

7. The apparatus of claim 2, wherein said compression columns and said second lever are pivotable to a position away from said valve spring to prevent obstruction at the time of removal or replacement of said valve seal or said valve spring.

8. The apparatus of claim 2, further comprises a keeper tool connected to said compression columns for installing valve keepers and/or said valve seat.

9. The apparatus of claim 2, further comprises a camshaft removal tool configured to mount over a cylinder head in order to remove a camshaft to access said valve spring.

10. The apparatus of claim 9, wherein said camshaft removal tool comprises:
a body comprising grooves;
extension legs extending from said body;
extension members extending from said body; and
extension arms extending from said body,
wherein said extension legs, said extension members, and said extension arms are operatively connected to cam caps and rocker arms positioned along said camshaft, and
wherein said camshaft removal tool is pressed to release springs of said camshaft.

11. An apparatus for compressing a valve spring in an internal combustion (IC) engine for removal or replacement of a valve seal or said valve spring, said apparatus comprising:
an elongated rod having a first end and a second end;
a first lever connected at said first end of said elongated rod;
a second lever slidably connected to said elongated rod;
compression columns pivotably connected to said second lever;
a keeper tool removably attached to said compression columns; and
fixing seats positioned at said elongated rod for securing said apparatus to an internal combustion (IC) engine,
wherein said second lever is pushed down such that said compression columns compress a valve spring for removal or replacement of a valve seal or said valve spring, and
wherein said keeper tool connects to said compression columns for installing valve keepers and/or said valve seat.

12. The apparatus of claim 11, wherein said compression columns comprise a compression bushing at distal end interfacing with said valve spring.

13. The apparatus of claim 11, wherein said second lever comprises an extending member connected to said elongated rod via a second lever connecting member.

14. The apparatus of claim 13, wherein said second lever extends at an angle from said extending member.

15. The apparatus of claim 13, wherein said compression columns connect to said extending member.

16. The apparatus of claim 13, wherein said compression columns and said second lever are pivotable to a position away from said valve spring to prevent obstruction at the time of removal or replacement of said valve seal or said valve spring.

17. The apparatus of claim 11, further comprises a camshaft removal tool configured to mount over a cylinder head in order to remove a camshaft to access said valve spring.

18. The apparatus of claim 17, wherein said camshaft removal tool comprises:
a body comprising grooves;
extension legs extending from said body;
extension members extending from said body; and
extension arms extending from said body,
wherein said extension legs, said extension members and said extension arms are operatively connected to cam caps and rocker arms positioned along said camshaft, and
wherein said camshaft removal tool is pressed to release springs of said camshaft.

19. A method of providing an apparatus for compressing a valve spring in an internal combustion (IC) engine for removal or replacement of a valve seal or said valve spring, said method comprising the steps of:
providing an elongated rod having a first end and a second end;
providing a first lever connected at said first end of said elongated rod;
providing a second lever slidably connected to said elongated rod;
providing compression columns pivotably connected to said second lever;
providing fixing seats positioned at said elongated rod for securing said apparatus to an internal combustion (IC) engine; and
pushing down said second lever such that said compression columns compress a valve spring for removal or replacement of a valve seal or said valve spring.

20. The method of claim 19, further comprising providing a keeper tool connected to said compression columns for installing valve keepers and/or said valve seat

21. The method of claim 19, further comprising a camshaft removal tool mounting over a cylinder head for removal of a camshaft to access said valve spring.
